(19) United States
(12) Patent Application Publication
(10) Pub. No.: US 2026/0220352 A1
(43) Pub. Date: Jul. 30, 2026

(54) System, Method, and Computer Program Product for Automatically Mapping Citations to Documents

(71) Applicant: Clearbrief, Inc., Seattle, WA (US)

(72) Inventors: Jacqueline Grace Schafer, Seattle, WA (US); Jose Demetrio Saura, Covington, WA (US)

(21) Appl. No.: 19/463,272

(22) Filed: Jan. 29, 2026

Related U.S. Application Data
(60) Provisional application No. 63/750,860, filed on Jan. 29, 2025.

(51) Int. Cl. G06F 40/134; G06F 16/93; G06F 40/114; G06F 40/205

(52) U.S. Cl. CPC G06F 40/134; G06F 16/93; G06F 40/114; G06F 40/205

(57) ABSTRACT

Provided are systems, methods, and computer program products for automatically mapping citations to documents. The system includes at least one processor configured to parse a textual document to identify a plurality of document citations each including a document identifier and a pinpoint citation, determine, with at least one machine-learning model, at least one candidate document for each document identifier in the plurality of document citations, determine a document from the plurality of documents based on the at least one candidate document for each document identifier of the plurality of document citations, determine a mapping between each pinpoint citation from the plurality of document citations and a pinpoint citation from the document corresponding to the document identifier for each document citation, and link the document and the pinpoint citation from the document to at least one document citation of the plurality of document citations.

### CROSS REFERENCE TO RELATED APPLICATION

The present application claims the benefit of U.S. Provisional Patent Application No. 63/750,860, filed Jan. 29, 2025, the disclosure of which is hereby incorporated by reference in its entirety.

### BACKGROUND

### 1. Field

This disclosure relates generally to document processing and, in some non-limiting embodiments or aspects, systems, methods, and computer program products for automatically mapping citations in a textual document.

### 2. Technical Considerations

A document may cite to several different documents, but the citations may not clearly identify a particular document among numerous documents or a pinpoint citation among numerous pages and/or paragraphs. As a result, a document cannot be linked to a citation in a document with confidence.

### SUMMARY

According to non-limiting embodiments or aspects, provided is a method comprising: parsing a textual document to identify a plurality of document citations, each document citation of the plurality of document citations comprising a document identifier and a pinpoint citation, each document citation corresponding to an assertion of a plurality of assertions in the textual document; determining, with at least one machine-learning model, at least one candidate document from a plurality of documents for each document identifier in the plurality of document citations; determining a document from the plurality of documents based on the at least one candidate document for each document identifier of the plurality of document citations; determining a mapping between each pinpoint citation from the plurality of document citations and a pinpoint citation from the document corresponding to the document identifier for each document citation of the plurality of document citations; and linking the document and the pinpoint citation from the document to at least one document citation of the plurality of document citations in the textual document.

In non-limiting embodiments or aspects, determining the at least one candidate document from the plurality of documents for each document identifier comprises: for each assertion of the plurality of assertions having a common document identifier, comparing the assertion to each document of the plurality of documents to determine a similarity score for each assertion and document pair, wherein each candidate document of the at least one candidate document has a similarity score, and wherein determining the document is based on the similarity score of each candidate document of the at least one candidate document. In non-limiting embodiments or aspects, determining the document from the plurality of documents based on the at least one candidate document for each document identifier of the plurality of document citations comprises: determining a probability for each assertion and document pair based on the similarity score for the assertion and document pair and one or more similarity scores for other pairs of the assertion and one or more other documents; and selecting the assertion and document pair based on the probability. In non-limiting embodiments or aspects, the mapping comprises a mapping between a page of the pinpoint citation in a document citation and pagination in the document. In non-limiting embodiments or aspects, determining the at least one candidate document from the plurality of documents for each document identifier in the plurality of document citations is based on a probability that the document identifier references each candidate document of the at least one candidate document.

In non-limiting embodiments or aspects, determining the mapping between each pinpoint citation from the plurality of document citations and the pinpoint citation from the document corresponding to the document identifier for each document citation of the plurality of document citations is based on plotting each pinpoint citation from the plurality of document citations with corresponding scores for each pinpoint citation. In non-limiting embodiments or aspects, wherein determining the mapping between each pinpoint citation from the plurality of document citations and the pinpoint citation from the document corresponding to the document identifier for each document citation of the plurality of document citations comprises: determining an offset value from the document based on one or more differences between the pinpoint citations and determined pinpoint citations based on comparing each assertion to each document of the plurality of documents. In non-limiting embodiments or aspects, each pinpoint citation comprises at least one page citation.

According to non-limiting embodiments or aspects, provided is a system comprising: at least one processor configured to: parse a textual document to identify a plurality of document citations, each document citation of the plurality of document citations comprising a document identifier and a pinpoint citation, each document citation corresponding to an assertion of a plurality of assertions in the textual document; determine, with at least one machine-learning model, at least one candidate document from a plurality of documents for each document identifier in the plurality of document citations; determine a document from the plurality of documents based on the at least one candidate document for each document identifier of the plurality of document citations; determine a mapping between each pinpoint citation from the plurality of document citations and a pinpoint citation from the document corresponding to the document identifier for each document citation of the plurality of document citations; and link the document and the pinpoint citation from the document to at least one document citation of the plurality of document citations in the textual document.

In non-limiting embodiments or aspects, determining the at least one candidate document from the plurality of documents for each document identifier comprises: for each assertion of the plurality of assertions having a common document identifier, comparing the assertion to each document of the plurality of documents to determine a similarity score for each assertion and document pair, wherein each candidate document of the at least one candidate document has a similarity score, and wherein determining the document is based on the similarity score of each candidate document of the at least one candidate document. In non-limiting embodiments or aspects, determining the document from the plurality of documents based on the at least one candidate document for each document identifier of the plurality of document citations comprises: determining a probability for each assertion and document pair based on the similarity score for the assertion and document pair and one or more similarity scores for other pairs of the assertion and one or more other documents; and selecting the assertion and document pair based on the probability.

In non-limiting embodiments or aspects, the mapping comprises a mapping between a page of the pinpoint citation in a document citation and pagination in the document. In non-limiting embodiments or aspects, wherein determining the at least one candidate document from the plurality of documents for each document identifier in the plurality of document citations is based on a probability that the document identifier references each candidate document of the at least one candidate document. In non-limiting embodiments or aspects, determining the mapping between each pinpoint citation from the plurality of document citations and the pinpoint citation from the document corresponding to the document identifier for each document citation of the plurality of document citations is based on plotting each pinpoint citation from the plurality of document citations with corresponding scores for each pinpoint citation. In non-limiting embodiments or aspects, determining the mapping between each pinpoint citation from the plurality of document citations and the pinpoint citation from the document corresponding to the document identifier for each document citation of the plurality of document citations comprises: determining an offset value from the document based on one or more differences between the pinpoint citations and determined pinpoint citations based on comparing each assertion to each document of the plurality of documents. In non-limiting embodiments or aspects, each pinpoint citation comprises at least one page citation.

According to non-limiting embodiments or aspects, provided is a computer program product comprising at least one non-transitory computer-readable medium including program instructions that, when executed by at least one processor, cause the at least one processor to: parse a textual document to identify a plurality of document citations, each document citation of the plurality of document citations comprising a document identifier and a pinpoint citation, each document citation corresponding to an assertion of a plurality of assertions in the textual document; determine, with at least one machine-learning model, at least one candidate document from a plurality of documents for each document identifier in the plurality of document citations; determine a document from the plurality of documents based on the at least one candidate document for each document identifier of the plurality of document citations; determine a mapping between each pinpoint citation from the plurality of document citations and a pinpoint citation from the document corresponding to the document identifier for each document citation of the plurality of document citations; and link the document and the pinpoint citation from the document to at least one document citation of the plurality of document citations in the textual document.

In non-limiting embodiments or aspects, wherein determining the at least one candidate document from the plurality of documents for each document identifier comprises: for each assertion of the plurality of assertions having a common document identifier, comparing the assertion to each document of the plurality of documents to determine a similarity score for each assertion and document pair, wherein each candidate document of the at least one candidate document has a similarity score, and wherein determining the document is based on the similarity score of each candidate document of the at least one candidate document. In non-limiting embodiments or aspects, wherein determining the document from the plurality of documents based on the at least one candidate document for each document identifier of the plurality of document citations comprises: determining a probability for each assertion and document pair based on the similarity score for the assertion and document pair and one or more similarity scores for other pairs of the assertion and one or more other documents; and selecting the assertion and document pair based on the probability. In non-limiting embodiments or aspects, the mapping comprises a mapping between a page of the pinpoint citation in a document citation and pagination in the document.

Further non-limiting embodiments and aspects are provided in the following clauses:

Clause 1: A method comprising: parsing a textual document to identify a plurality of document citations, each document citation of the plurality of document citations comprising a document identifier and a pinpoint citation, each document citation corresponding to an assertion of a plurality of assertions in the textual document; determining, with at least one machine-learning model, at least one candidate document from a plurality of documents for each document identifier in the plurality of document citations; determining a document from the plurality of documents based on the at least one candidate document for each document identifier of the plurality of document citations; determining a mapping between each pinpoint citation from the plurality of document citations and a pinpoint citation from the document corresponding to the document identifier for each document citation of the plurality of document citations; and linking the document and the pinpoint citation from the document to at least one document citation of the plurality of document citations in the textual document.

Clause 2: The method of clause 1, wherein determining the at least one candidate document from the plurality of documents for each document identifier comprises: for each assertion of the plurality of assertions having a common document identifier, comparing the assertion to each document of the plurality of documents to determine a similarity score for each assertion and document pair, wherein each candidate document of the at least one candidate document has a similarity score, and wherein determining the document is based on the similarity score of each candidate document of the at least one candidate document.

Clause 3: The method of clause 1 or 2, wherein determining the document from the plurality of documents based on the at least one candidate document for each document identifier of the plurality of document citations comprises: determining a probability for each assertion and document pair based on the similarity score for the assertion and document pair and one or more similarity scores for other pairs of the assertion and one or more other documents; and selecting the assertion and document pair based on the probability.

Clause 4: The method of any of clauses 1-3, wherein the mapping comprises a mapping between a page of the pinpoint citation in a document citation and pagination in the document.

Clause 5: The method of any of clauses 1-4, wherein determining the at least one candidate document from the plurality of documents for each document identifier in the plurality of document citations is based on a probability that the document identifier references each candidate document of the at least one candidate document.

Clause 6: The method of any of clauses 1-5, wherein determining the mapping between each pinpoint citation from the plurality of document citations and the pinpoint citation from the document corresponding to the document identifier for each document citation of the plurality of document citations is based on plotting each pinpoint citation from the plurality of document citations with corresponding scores for each pinpoint citation.

Clause 7: The method of any of clauses 1-6, wherein determining the mapping between each pinpoint citation from the plurality of document citations and the pinpoint citation from the document corresponding to the document identifier for each document citation of the plurality of document citations comprises: determining an offset value from the document based on one or more differences between the pinpoint citations and determined pinpoint citations based on comparing each assertion to each document of the plurality of documents.

Clause 8: The method of any of clauses 1-7, wherein each pinpoint citation comprises at least one page citation.

Clause 9: A system comprising: at least one processor configured to: parse a textual document to identify a plurality of document citations, each document citation of the plurality of document citations comprising a document identifier and a pinpoint citation, each document citation corresponding to an assertion of a plurality of assertions in the textual document; determine, with at least one machine-learning model, at least one candidate document from a plurality of documents for each document identifier in the plurality of document citations; determine a document from the plurality of documents based on the at least one candidate document for each document identifier of the plurality of document citations; determine a mapping between each pinpoint citation from the plurality of document citations and a pinpoint citation from the document corresponding to the document identifier for each document citation of the plurality of document citations; and link the document and the pinpoint citation from the document to at least one document citation of the plurality of document citations in the textual document.

Clause 10: The system of clause 9, wherein determining the at least one candidate document from the plurality of documents for each document identifier comprises: for each assertion of the plurality of assertions having a common document identifier, comparing the assertion to each document of the plurality of documents to determine a similarity score for each assertion and document pair, wherein each candidate document of the at least one candidate document has a similarity score, and wherein determining the document is based on the similarity score of each candidate document of the at least one candidate document.

Clause 11: The system of clause 9 or 10, wherein determining the document from the plurality of documents based on the at least one candidate document for each document identifier of the plurality of document citations comprises: determining a probability for each assertion and document pair based on the similarity score for the assertion and document pair and one or more similarity scores for other pairs of the assertion and one or more other documents; and selecting the assertion and document pair based on the probability.

Clause 12: The system of any of clauses 9-11, wherein the mapping comprises a mapping between a page of the pinpoint citation in a document citation and pagination in the document.

Clause 13: The system of any of clauses 9-12, wherein determining the at least one candidate document from the plurality of documents for each document identifier in the plurality of document citations is based on a probability that the document identifier references each candidate document of the at least one candidate document.

Clause 14: The system of any of clauses 9-13, wherein determining the mapping between each pinpoint citation from the plurality of document citations and the pinpoint citation from the document corresponding to the document identifier for each document citation of the plurality of document citations is based on plotting each pinpoint citation from the plurality of document citations with corresponding scores for each pinpoint citation.

Clause 15: The system of any of clauses 9-14, wherein determining the mapping between each pinpoint citation from the plurality of document citations and the pinpoint citation from the document corresponding to the document identifier for each document citation of the plurality of document citations comprises: determining an offset value from the document based on one or more differences between the pinpoint citations and determined pinpoint citations based on comparing each assertion to each document of the plurality of documents.

Clause 16: The system of any of clauses 9-15, wherein each pinpoint citation comprises at least one page citation.

Clause 17: A computer program product comprising at least one non-transitory computer-readable medium including program instructions that, when executed by at least one processor, cause the at least one processor to: parse a textual document to identify a plurality of document citations, each document citation of the plurality of document citations comprising a document identifier and a pinpoint citation, each document citation corresponding to an assertion of a plurality of assertions in the textual document; determine, with at least one machine-learning model, at least one candidate document from a plurality of documents for each document identifier in the plurality of document citations; determine a document from the plurality of documents based on the at least one candidate document for each document identifier of the plurality of document citations; determine a mapping between each pinpoint citation from the plurality of document citations and a pinpoint citation from the document corresponding to the document identifier for each document citation of the plurality of document citations; and link the document and the pinpoint citation from the document to at least one document citation of the plurality of document citations in the textual document.

Clause 18: The computer program product of clause 17, wherein determining the at least one candidate document from the plurality of documents for each document identifier comprises: for each assertion of the plurality of assertions having a common document identifier, comparing the assertion to each document of the plurality of documents to determine a similarity score for each assertion and document pair, wherein each candidate document of the at least one candidate document has a similarity score, and wherein determining the document is based on the similarity score of each candidate document of the at least one candidate document.

Clause 19: The computer program product of clause 17 or 18, wherein determining the document from the plurality of documents based on the at least one candidate document for each document identifier of the plurality of document citations comprises: determining a probability for each assertion and document pair based on the similarity score for the assertion and document pair and one or more similarity scores for other pairs of the assertion and one or more other documents; and selecting the assertion and document pair based on the probability.

Clause 20: The computer program product of any of clauses 17-19, wherein the mapping comprises a mapping between a page of the pinpoint citation in a document citation and pagination in the document.

These and other features and characteristics of the present disclosure, as well as the methods of operation and functions of the related elements of structures and the combination of parts and economies of manufacture, will become more apparent upon consideration of the following description and the appended claims with reference to the accompanying drawings, all of which form a part of this specification, wherein like reference numerals designate corresponding parts in the various figures. It is to be expressly understood, however, that the drawings are for the purpose of illustration and description only and are not intended as a definition of the limits of the invention.

### BRIEF DESCRIPTION OF THE DRAWINGS

Additional advantages and details are explained in greater detail below with reference to the non-limiting, exemplary embodiments that are illustrated in the accompanying schematic figures, in which:

FIG. 1 illustrates a schematic diagram of a system for automatically mapping citations to documents according to non-limiting embodiments or aspects;

FIG. 2 illustrates a flow diagram for a method for automatically mapping citations to documents according to non-limiting embodiments or aspects;

FIG. 3 illustrates example components of a device used in connection with non-limiting embodiments or aspects of systems, methods, and computer program products for automatically mapping citations to documents; and

FIG. 4 illustrates a chart with a citation page mapping according to non-limiting embodiments or aspects.

### DESCRIPTION

For purposes of the description hereinafter, the terms “end,” “upper,” “lower,” “right,” “left,” “vertical,” “horizontal,” “top,” “bottom,” “lateral,” “longitudinal,” and derivatives thereof shall relate to the embodiments as they are oriented in the drawing figures. However, it is to be understood that the embodiments may assume various alternative variations and step sequences, except where expressly specified to the contrary. It is also to be understood that the specific devices and processes illustrated in the attached drawings, and described in the following specification, are simply exemplary embodiments or aspects of the invention. Hence, specific dimensions and other physical characteristics related to the embodiments or aspects disclosed herein are not to be considered as limiting.

No aspect, component, element, structure, act, step, function, instruction, and/or the like used herein should be construed as critical or essential unless explicitly described as such. Also, as used herein, the articles “a” and “an” are intended to include one or more items and may be used interchangeably with “one or more” and “at least one.” Furthermore, as used herein, the term “set” is intended to include one or more items (e.g., related items, unrelated items, a combination of related and unrelated items, and/or the like) and may be used interchangeably with “one or more” or “at least one.” Where only one item is intended, the term “one” or similar language is used. Also, as used herein, the terms “has,” “have,” “having,” or the like are intended to be open-ended terms. Further, the phrase “based on” is intended to mean “based at least partially on” unless explicitly stated otherwise.

As used herein, the term “computing device” may refer to one or more electronic devices configured to process data. A computing device may, in some examples, include the necessary components to receive, process, and output data, such as a processor, a display, a memory, an input device, a network interface, and/or the like. A computing device may be a mobile device. As an example, a mobile device may include a cellular phone (e.g., a smartphone or standard cellular phone), a portable computer, a wearable device (e.g., watches, glasses, lenses, clothing, and/or the like), a personal digital assistant (PDA), and/or other like devices. A computing device may also be a desktop computer, server, or other form of non-mobile computer.

As used herein, the term “server” may refer to or include one or more computing devices that are operated by or facilitate communication and processing for multiple parties in a network environment, such as the Internet, although it will be appreciated that communication may be facilitated over one or more public or private network environments and that various other arrangements are possible. Further, multiple computing devices (e.g., servers, mobile devices, etc.) directly or indirectly communicating in the network environment may constitute a “system.” Reference to “a server” or “a processor,” as used herein, may refer to a previously-recited server and/or processor that is recited as performing a previous step or function, a different server and/or processor, and/or a combination of servers and/or processors. For example, as used in the specification and the claims, a first server and/or a first processor that is recited as performing a first step or function may refer to the same or different server and/or a processor recited as performing a second step or function.

A textual document, such as but not limited to a legal brief, may contain many citations that reference documents (for example, content from a PDF document, Word document, email file, TIFF image, and/or the like). For example, a section of a brief might say: “John Doe was born in Covington, WA. Tr. 42”. Associating a citation (for example, “Tr. 42”) with a specific document and a specific page in that document is a tedious task and is prone to errors when automated. As the number of citations and files/documents grows, the problem becomes exponentially more difficult. Provided herein are systems, methods, and computer program products for automatically mapping citations in a textual document to documents (e.g., such as record documents for a case, including but not limited to transcripts, pleadings, emails, and/or the like) that improve upon existing word processing systems and/or document citation systems. In non-limiting embodiments, a similarity measure between text cited (e.g., an assertion) from multiple citations is performed against all the available documents or all of a subset of documents to compute the probability that a citation style (for example, “Tr.” for a transcript) references a particular document from a given set of documents. After the document that is related to “Tr.”-like citations is determined, a mapping table may be generated for the pages cited and the actual physical page in the document.

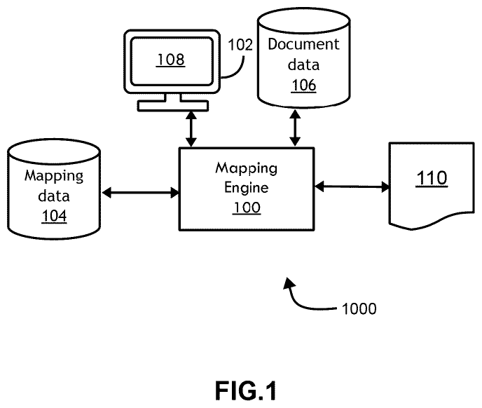

Referring now to FIG. 1, a system 1000 for automatically mapping citations to documents is shown according to non-limiting embodiments. The system 1000 includes a mapping engine 100, which may include one or more computing devices and/or software applications executed by one or more computing devices. In some non-limiting embodiments, the mapping engine 100 may be part of and/or be executed by a client computing device 102. Additionally or alternatively, the mapping engine 100 may be executed by one or more servers in communication with the client computing device 102. For example, the mapping engine 100 may be one or more client-side applications, one or more server-side applications, or a combination of client-side and server-side applications. It will be appreciated that different arrangements of computing devices may be used in some non-limiting embodiments.

With continued reference to FIG. 1, in some non-limiting embodiments the client computing device 102 may execute a word processing application or be in communication with a word processing application service. The word processing application may display a graphical user interface (GUI) 108 on the client computing device 102. The GUI 108 may display a textual document 110. A user of the client computing device 102 may draft, edit, save, view, and interact with the textual document 110. The client computing device 102 may locally store the textual document 110 and/or the textual document may be displayed from remote storage. The textual document 110 may also be displayed on a document reading application such that it cannot be edited but a user can select text.

In some non-limiting embodiments, the mapping engine 100 may be in communication with document data 106 stored on one or more data storage devices. The document data 106 may be local or remote to the client computing device 102 and/or mapping engine 100. The document data 106 may include documents associated with the textual document 110, such as one or more transcripts, records, pleadings, briefs, orders, court decisions, evidentiary documents, and/or the like. The documents may be uploaded by a user of the computing device 102 and/or may be identified based on a case or the textual document 110. Although the document data 106 is shown in FIG. 1 stored on a single data storage device, it will be appreciated that any number of data storage devices may be used in some non-limiting embodiments, arranged local and/or remote to the computing device 102.

With continued reference to FIG. 1, the mapping engine and/or another system or application may parse the textual document 110 to identify a plurality of document citations. Each document citation of the plurality of document citations may include a document identifier and a pinpoint citation, and each document citation may correspond to an assertion of a plurality of assertions in the textual document. For example, a document identifier may be “Tr.”, “ER”, “Smith”, “Dkt”, “Wilson Tr.”, and/or the like, used in the textual document 110. A pinpoint citation may be a page number, line number, paragraph number, and/or the like. For example, “Tr. 5” may intend to refer to page 5 of a transcript. An assertion may include text that precedes the document citation, such as “Joe lives on Walnut Street” followed by the document citation “Tr. 5”. It will be appreciated that various forms of assertions and document citations may be used.

With continued reference to FIG. 1, the mapping engine 100 and/or another system or application may process a plurality of documents from the document data 106. For example, a plurality of documents associated with the textual document 110 may be retrieved from the document data 106 so that the assertion for each document citation can be compared to each document of the plurality of documents. Based on a similarity score, one or more candidate documents are identified from the plurality of documents. For example, comparing an assertion (e.g., “Joe lives on Walnut Street”) to each of a plurality of documents may yield varying degrees of similarity across one, two, or multiple documents. Each document having a similarity score that satisfies a threshold (e.g., is not null or is at least a certain score value) may be considered a candidate document. In some examples, a machine-learning model may be used to determine the one or more candidate documents from the plurality of documents. This process may include determining a similarity score for each candidate document for each document citation. For example, if the document citation “Tr. 5” for the assertion “Joe lives on Walnut Street” yields three possible documents, a score is generated for each of the three documents for that assertion.

As another example, a brief with two citations and the corresponding assertions as shown in the table below may be associated with the listed candidate documents (e.g., file1.pdf, file2.pdf, and file3.pdf) and pinpoint citations.

| Assertion | Citation | Candidates |
|---|---|---|
| John Doe was born in | Tr. 12 | file1.pdf, page 10,14; file2.pdf, |
| Covington, WA | | page 3 |
| Mary Doe attended | Tr. 23 | file1.pdf, page 20, 25; file3.pdf, |
| Bellevue College | | page 8 |

Once one or more candidate documents are identified for each document citation, a document may be determined for each document identifier in each of the plurality of document citations. In the above example, it may be determined that the document identifier “Tr.” refers to the document “file1.pdf”. This can be determined based on both instances of “Tr.” being associated with “file1.pdf” as a candidate and being inconsistent on “file2.pdf” and “file3.pdf.” Thus, “file1.pdf” has a frequency score of two and both of “file2.pdf” and “file3.pdf” have a frequency score of one. Further, “file1.pdf” has a page cited score of four whereas the other documents have a single page cited for each. Using either score or a combination of both, “file1.pdf” can be selected.

Still referring to FIG. 1, the mapping engine 100 and/or another system or application may determine a mapping between each pinpoint citation from the plurality of document citations and a pinpoint citation from the document corresponding to the document identifier for each document citation of the plurality of document citations. The mapping may be determined from an offset value representing a difference in the pagination of a document and the actual pages of that document (e.g., where “page 1” is the second or third page of an electronic document or the like). A mapping table that maps each document identifier to a document and to a pinpoint citation offset value may be stored as mapping data 104 in one or more data storage devices local and/or remote to the mapping engine 100.

In the above example involving “Tr.” and “file1.pdf”, the following pinpoint citation mapping may be generated:

| Cited Page Number | Physical Document Page |
|---|---|
| 12 | 14 |
| 13 | 15 |
| 14 | 16 |
| . . . | . . . |
| 23 | 25 |

In the above example, there is a two-page offset between the cited page number and the actual page number of the document. This may be the result of cover pages and other content at the beginning and/or throughout the document. Thus, the offset value may not be the same for every page, depending on where in the document the citation is for, and may change throughout the document. In the above example, “Tr. 12” is on page 14 of the document counting each page from the first actual page regardless of pagination or content.

In some non-limiting embodiments, the document and the pinpoint citation from the document may be linked to at least one document citation of the plurality of document citations in the textual document.

In non-limiting embodiments, an algorithm for determining candidate documents may be as follows:
Let:
R={R₁, R₂, . . . Rₙ}, set of all documents in a matter;
Cᵢ={Cᵢⱼ, Cᵢ₂ . . . , Cᵢₙ}, set of citations with style i;
Aᵢ={Aᵢⱼ, Aᵢ₂, . . . Aᵢₙ}, set of phrases cited by citations Cᵢⱼ (all citations with style i);
Sᵢₖ={sᵢⱼₖ, sᵢ₂ₖ, . . . sᵢₙₖ} similarity scores between elements of Aᵢ and the k Record doc.

$$P ( {C}_{i j} ∈ {R}_{k} ) = \frac{{s}_{i j k}}{{\sum }_{k}^{n} {s}_{i j k}}$$

where P(Cᵢⱼ∈Rₖ) is the probability that the citation j with style i belongs to the document Rₖ,

The probability is defined as the score of the assertion of the citation Cᵢⱼ in the document k, divided by the sum of all scores of that assertion for every document. The probability that a citation of style i, references a particular document k, is represented as:

$$P ( Ci ∈ {R}_{k} ) = {\prod }_{j} P ( {C}_{ij} ∈ {R}_{k} )$$

As an example, a textual document may include the following assertions and citations:
“John Doe was born in Covington. WA Tr. 42”
“John works at Clearbrief. Tr. 24” “Mary
Doe attended Bellevue College. Mary's depo at 34”

There may be three documents, R1, R2, and R3. The cosine similarity scores between the assertions and the document (or the greatest score of similarity when the comparison is made against every page and/or chunk of the document) may be as follows:

| Assertion | Document | Score |
|---|---|---|
| John Doe was born in | R1 | 0.7 |
| Covington, WA (Tr. 42) | | |
| John Doe was born in | R2 | 0.2 |
| Covington, WA | | |
| John Doe was born in | R3 | 0.3 |
| Covington, WA | | |
| John works at Clearbrief (Tr. | R1 | 0.8 |
| 24) | | |
| John works at Clearbrief | R2 | 0.4 |
| John works at Clearbrief | R3 | 0.5 |
| Mary Doe attended Bellevue | R1 | 0.1 |
| College (Mary depo at 34) | | |
| Mary Doe attended Bellevue | R2 | 0.5 |
| College | | |
| Mary Doe attended Bellevue | R3 | 0 |
| College | | |

In the above example, the probability that the citation “Tr. 42” references document R1 is: P(C_{1,1}, R₁)=0.7/(0.7+0.2+0.3)=0.58.

The same probability may be calculated for all other citations and document combinations as follows:

$$P ( {C}_{1 , 1} , {R}_{2} ) = 0.2 / ( 0.7 + 0.2 + 0.3 ) = 0.17 ;$$

$$P ( {C}_{1 , 1} , {R}_{3} ) = 0.3 / ( 0.7 + 0.2 + 0.3 ) = 0 \text{.25} ;$$

$$P ( {C}_{1 , 2} , {R}_{1} ) = 0.8 / ( 0.8 + 0.4 + 0.5 ) = 0.47 ;$$

$$P ( {C}_{1 , 2} , {R}_{2} ) = 0.4 / ( 0.8 + 0.4 + 0.5 ) = 0.24 ;$$

$$P ( {C}_{1 , 2} , {R}_{3} ) = 0.5 / ( 0.8 + 0.4 + 0.5 ) = 0.29 ;$$

$$P ( {C}_{2 , 1} , {R}_{1} ) = 0.1 / ( 0.5 + 0.1 + 0 ) = 0 \text{.17} ;$$

$$P ( {C}_{2 , 1} , {R}_{2} ) = 0.5 / ( 0.5 + 0.1 + 0 ) = 0 \text{.83} ;$$

$$P ( {C}_{2 , 1} , {R}_{3} ) = 0 / ( 0.5 + 0.1 + 0 ) = 0 .$$

The probabilities that the citation style Tr references documents R1, R2, R3 are:

$$P ( {C}_{1} , {R}_{1} ) = 0.58 * 0.47 = 0.27 ;$$

$$P ( {C}_{1} , {R}_{2} ) = 0.17 * 0.24 = 0 \text{.04} ;$$

$$P ( {C}_{1} , {R}_{3} ) = 0.25 * 0.29 = 0.07 .$$

Based on these probabilities, it can be inferred that “Tr.” citations refer to R1 because it has the highest probability.

In non-limiting embodiments, mappings may be determined between the pages of one or more documents. For example, a citation “Tr.12” references page 12 but might not correspond with the physical page number 12 of a document. For example, if the document has a cover page, the citation “Tr.1” may correspond the physical page number 2 if the cover page is skipped (e.g., not paginated). Other pages and pagination schemas at the beginning and/or throughout the document may affect a difference between the target cite (matching the pagination) and the actual page of the document starting from the beginning or some other set point.

To calculate the mapping, in non-limiting embodiments an algorithm may use the same scores obtained for the assertions during the previous phase. In addition to the scores, when computing similarity, the page of the document that is compared may be recorded. An example mapping table is as follows:

| Assertion | Document | Physical Page | Score |
|---|---|---|---|
| John Doe was born in | R1 | 43 | 0.7 |
| Covington, WA (Tr. | | | |
| 42) | | | |
| John Doe was born in | R2 | 30 | 0.2 |
| Covington, WA | | | |
| John Doe was born in | R3 | 8 | 0.3 |
| Covington, WA | | | |
| John works at | R1 | 25 | 0.8 |
| Clearbrief (Tr. 24) | | | |
| John works at | R2 | 3 | 0.4 |
| Clearbrief | | | |
| John works at | R3 | 7 | 0.5 |
| Clearbrief | | | |
| Mary Doe attended | R1 | 18 | 0.1 |
| Bellevue College | | | |
| (Mary depo at 34) | | | |
| Mary Doe attended | R2 | 34 | 0.5 |
| Bellevue College | | | |
| Mary Doe attended | R3 | 15 | 0 |
| Bellevue College | | | |

After it is determined that citations of type Tr. reference the document R1, only those parameters may be selected in the mapping table and the following mappings may be obtained: Tr.42->Page 43 and Tr.24->Page 25

In non-limiting embodiments, the mapping table may be generated programmatically while accounting for one or more potential errors. For example, it is possible that Tr.24->Page 25 had the second highest score and Tr.24->Page 20 had the higher score even if it was not the correct page.

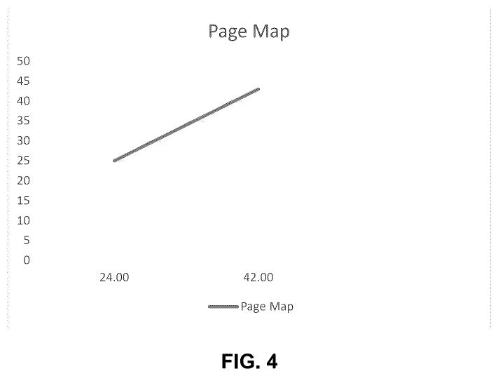

Since the mapping is linear, the results may be plotted as shown in FIG. 4 and the equation of the line that best fits the points may be calculated using, as an example, the least squares method and/or other like method. As an example, FIG. 4 shows an example line that fits the points, where both axes represent the page numbers, such that a Y-axis represents a cited page and the X-axis represents the actual page, or vice versa. In such an example, a pointed is plotted for each citation such that the cited page is on a first axis and the mapped page is on a second axis. It will be appreciated that other approaches to mapping the citations may be used in non-limiting embodiments.

Once the parameters of the line (y=mx+b) are obtained, the points may be validated by comparing the values of the table against the value obtained using the line equation. Values that do not match can then be autocorrected. The value of b represents the offset (number of cover pages before page 1).

From the data, the following may be calculated:

$$y = m x + b ;$$

$$m = ( 43 - 25 ) / ( 42 / 24 ) = 18 / 18 = 1 ;$$

$$b = y - m x , y = 25 , x = 24 , b = 25 - 1 * 24 = 1 ;$$

To convert any citation like Tr. X and to obtain the physical page, the following calculation may be performed: Tr. 30->30*1+1=31.

In non-limiting embodiments, the mapping of document citations to documents is performed automatically based on information contained in the textual document. In some examples, this may be performed without human input. As an example, if the assertions for ten document citations with style “ER<number>” are more similar to content in “document1.pdf” than in “document2.pdf”, then citations with the pattern “ER<number>” are more likely to be in “document1.pdf.”

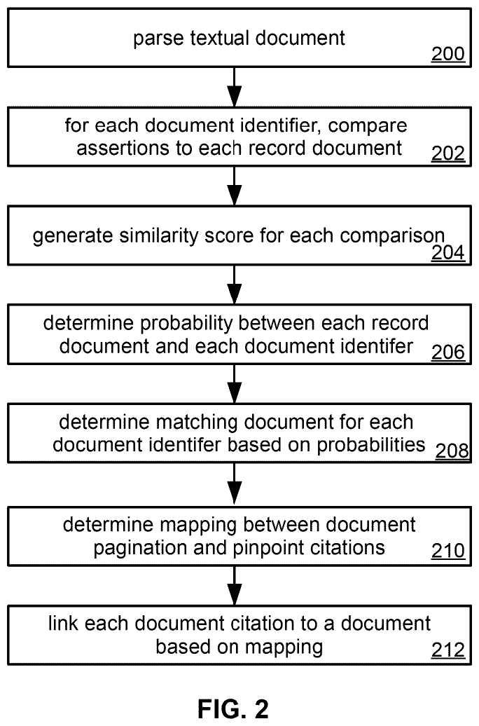

Referring now to FIG. 2, a flow chart is shown for automatically mapping citations to documents according to non-limiting embodiments. The steps shown in FIG. 2 are for example purposes only. It will be appreciated that non-limiting embodiments may involve additional steps, fewer steps, different steps, and/or a different order of steps. In some non-limiting embodiments or aspects, a step may be performed automatically in response to the completion of a previous step (e.g., may be performed without user intervention upon the completion of a previous step).

At step 200 of FIG. 2, a textual document may be parsed to identify document citations that may each include, for example, a document identifier and a pinpoint citation associated with an assertion (e.g., such as a quotation and/or statement based on a document). For example, document identifiers may be identified such as but not limited to “Tr”, “Transcript”, “Depo”, “Ex”, “Exhibit”, “Doc”, “Dkt”, “[Name] Tr”, and/or the like. Pinpoint citations to pages, paragraphs, lines, and/or the like may also be identified (e.g., “Tr. At 5”).

At step 202, for each document identifier (e.g., “Tr”) in the textual document, all the document citations may be identified so that each assertion can be compared to each document. For example, each instance of “Tr” may be identified and, for each instance, the assertion (e.g., a string of text, such as a sentence, preceding the document citation) may be compared to each document of a plurality of documents (e.g., a set of documents associated with the textual document). The comparison may be on a document-by-document basis, a page-by-page basis, and/or the like. This may be repeated for each unique document identifier in the textual document. At step 204, a similarity score is generated. The score may be generated as part of the comparison such that the comparison is performed by a similarity measurement (e.g., cosine similarity and/or the like) which outputs a similarity score.

At step 206, a probability is determined for each record document and document identifier pair. For example, if there are three documents, the probability of each document being associated with the document identifier may be determined such that there are three probability results. At step 208, a matching document is identified for each document identifier based on having a highest probability score. It will be appreciated that various algorithms and/or calculations may be used to determine the probability in non-limiting embodiments.

At step 210, a mapping is determined between the document pagination and the pinpoint citations of each document citation. For example, if a pinpoint citation is for “5” (e.g., page 5), a mapping between the pinpoint citation of “5” and the actual page of the document (e.g., counting from the first page of the electronic file without regard to cover pages or other content, as an example) may be determined and stored in a mapping table. This may be performed separately from or concurrently with steps 202-208.

At step 212, each document citation is linked to a document based on the mapping. For example, a citation to “Tr. 5” may link to a sixth page of a document (e.g., “file1.pdf”) such that clicking the citation causes the sixth page of the document to be displayed.

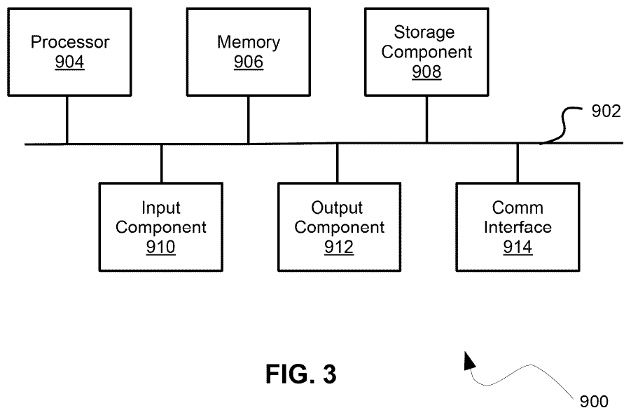

Referring now to FIG. 3, shown is a diagram of example components of a computing device 900 for implementing and performing the systems and methods described herein according to non-limiting embodiments. In some non-limiting embodiments, device 900 may include additional components, fewer components, different components, or differently arranged components than those shown in FIG. 3. Device 900 may correspond to the computing device 102 and/or mapping engine 100 shown in FIG. 1. Device 900 may include a bus 902, a processor 904, memory 906, a storage component 908, an input component 910, an output component 912, and a communication interface 914. Bus 902 may include a component that permits communication among the components of device 900. In some non-limiting embodiments, processor 904 may be implemented in hardware, firmware, or a combination of hardware and software. For example, processor 904 may include a processor (e.g., a central processing unit (CPU), a graphics processing unit (GPU), an accelerated processing unit (APU), etc.), a microprocessor, a digital signal processor (DSP), and/or any processing component (e.g., a field-programmable gate array (FPGA), an application-specific integrated circuit (ASIC), etc.) that can be programmed or configured to perform a function. Memory 906 may include random access memory (RAM), read only memory (ROM), and/or another type of dynamic or static storage device (e.g., flash memory, magnetic memory, optical memory, etc.) that stores information and/or instructions for use by processor 904.

With continued reference to FIG. 3, storage component 908 may store information and/or software related to the operation and use of device 900. For example, storage component 908 may include a hard disk (e.g., a magnetic disk, an optical disk, a magneto-optic disk, a solid state disk, etc.) and/or another type of computer-readable medium. Input component 910 may include a component that permits device 900 to receive information, such as via user input (e.g., a touch screen display, a keyboard, a keypad, a mouse, a button, a switch, a microphone, etc.). Additionally, or alternatively, input component 910 may include a sensor for sensing information (e.g., a global positioning system (GPS) component, an accelerometer, a gyroscope, an actuator, etc.). Output component 912 may include a component that provides output information from device 900 (e.g., a display, a speaker, one or more light-emitting diodes (LEDs), etc.). Communication interface 914 may include a transceiver-like component (e.g., a transceiver, a separate receiver and transmitter, etc.) that enables device 900 to communicate with other devices, such as via a wired connection, a wireless connection, or a combination of wired and wireless connections. Communication interface 914 may permit device 900 to receive information from another device and/or provide information to another device. For example, communication interface 914 may include an Ethernet interface, an optical interface, a coaxial interface, an infrared interface, a radio frequency (RF) interface, a universal serial bus (USB) interface, a Wi-Fi® interface, a cellular network interface, and/or the like.

Device 900 may perform one or more processes described herein. Device 900 may perform these processes based on processor 904 executing software instructions stored by a computer-readable medium, such as memory 906 and/or storage component 908. A computer-readable medium may include any non-transitory memory device. A memory device includes memory space located inside of a single physical storage device or memory space spread across multiple physical storage devices. Software instructions may be read into memory 906 and/or storage component 908 from another computer-readable medium or from another device via communication interface 914. When executed, software instructions stored in memory 906 and/or storage component 908 may cause processor 904 to perform one or more processes described herein. Additionally, or alternatively, hardwired circuitry may be used in place of or in combination with software instructions to perform one or more processes described herein. Thus, embodiments described herein are not limited to any specific combination of hardware circuitry and software. The term “programmed or configured,” as used herein, refers to an arrangement of software, hardware circuitry, or any combination thereof on one or more devices.

Although embodiments have been described in detail for the purpose of illustration, it is to be understood that such detail is solely for that purpose and that the disclosure is not limited to the disclosed embodiments or aspects, but, on the contrary, is intended to cover modifications and equivalent arrangements that are within the spirit and scope of the appended claims. For example, it is to be understood that the present disclosure contemplates that, to the extent possible, one or more features of any embodiment or aspect can be combined with one or more features of any other embodiment or aspect.

What is claimed is:

1. A method comprising:
parsing a textual document to identify a plurality of document citations, each document citation of the plurality of document citations comprising a document identifier and a pinpoint citation, each document citation corresponding to an assertion of a plurality of assertions in the textual document;
determining, with at least one machine-learning model, at least one candidate document from a plurality of documents for each document identifier in the plurality of document citations;
determining a document from the plurality of documents based on the at least one candidate document for each document identifier of the plurality of document citations;
determining a mapping between each pinpoint citation from the plurality of document citations and a pinpoint citation from the document corresponding to the document identifier for each document citation of the plurality of document citations; and
linking the document and the pinpoint citation from the document to at least one document citation of the plurality of document citations in the textual document.

2. The method of claim 1, wherein determining the at least one candidate document from the plurality of documents for each document identifier comprises:
for each assertion of the plurality of assertions having a common document identifier, comparing the assertion to each document of the plurality of documents to determine a similarity score for each assertion and document pair, wherein each candidate document of the at least one candidate document has a similarity score, and wherein determining the document is based on the similarity score of each candidate document of the at least one candidate document.

3. The method of claim 2, wherein determining the document from the plurality of documents based on the at least one candidate document for each document identifier of the plurality of document citations comprises:
determining a probability for each assertion and document pair based on the similarity score for the assertion and document pair and one or more similarity scores for other pairs of the assertion and one or more other documents; and
selecting the assertion and document pair based on the probability.

4. The method of claim 1, wherein the mapping comprises a mapping between a page of the pinpoint citation in a document citation and pagination in the document.

5. The method of claim 1, wherein determining the at least one candidate document from the plurality of documents for each document identifier in the plurality of document citations is based on a probability that the document identifier references each candidate document of the at least one candidate document.

6. The method of claim 1, wherein determining the mapping between each pinpoint citation from the plurality of document citations and the pinpoint citation from the document corresponding to the document identifier for each document citation of the plurality of document citations is based on plotting each pinpoint citation from the plurality of document citations with corresponding scores for each pinpoint citation.

7. The method of claim 1, wherein determining the mapping between each pinpoint citation from the plurality of document citations and the pinpoint citation from the document corresponding to the document identifier for each document citation of the plurality of document citations comprises:
determining an offset value from the document based on one or more differences between the pinpoint citations and determined pinpoint citations based on comparing each assertion to each document of the plurality of documents.

8. The method of claim 1, wherein each pinpoint citation comprises at least one page citation.

9. A system comprising:
at least one processor configured to:
parse a textual document to identify a plurality of document citations, each document citation of the plurality of document citations comprising a document identifier and a pinpoint citation, each document citation corresponding to an assertion of a plurality of assertions in the textual document;
determine, with at least one machine-learning model, at least one candidate document from a plurality of documents for each document identifier in the plurality of document citations;
determine a document from the plurality of documents based on the at least one candidate document for each document identifier of the plurality of document citations;
determine a mapping between each pinpoint citation from the plurality of document citations and a pinpoint citation from the document corresponding to the document identifier for each document citation of the plurality of document citations; and
link the document and the pinpoint citation from the document to at least one document citation of the plurality of document citations in the textual document.

10. The system of claim 9, wherein determining the at least one candidate document from the plurality of documents for each document identifier comprises:
for each assertion of the plurality of assertions having a common document identifier, comparing the assertion to each document of the plurality of documents to determine a similarity score for each assertion and document pair, wherein each candidate document of the at least one candidate document has a similarity score, and wherein determining the document is based on the similarity score of each candidate document of the at least one candidate document.

11. The system of claim 10, wherein determining the document from the plurality of documents based on the at least one candidate document for each document identifier of the plurality of document citations comprises:
determining a probability for each assertion and document pair based on the similarity score for the assertion and document pair and one or more similarity scores for other pairs of the assertion and one or more other documents; and
selecting the assertion and document pair based on the probability.

12. The system of claim 9, wherein the mapping comprises a mapping between a page of the pinpoint citation in a document citation and pagination in the document.

13. The system of claim 9, wherein determining the at least one candidate document from the plurality of documents for each document identifier in the plurality of document citations is based on a probability that the document identifier references each candidate document of the at least one candidate document.

14. The system of claim 9, wherein determining the mapping between each pinpoint citation from the plurality of document citations and the pinpoint citation from the document corresponding to the document identifier for each document citation of the plurality of document citations is based on plotting each pinpoint citation from the plurality of document citations with corresponding scores for each pinpoint citation.

15. The system of claim 9, wherein determining the mapping between each pinpoint citation from the plurality of document citations and the pinpoint citation from the document corresponding to the document identifier for each document citation of the plurality of document citations comprises:
determining an offset value from the document based on one or more differences between the pinpoint citations and determined pinpoint citations based on comparing each assertion to each document of the plurality of documents.

16. The system of claim 9, wherein each pinpoint citation comprises at least one page citation.

17. A computer program product comprising at least one non-transitory computer-readable medium including program instructions that, when executed by at least one processor, cause the at least one processor to:
parse a textual document to identify a plurality of document citations, each document citation of the plurality of document citations comprising a document identifier and a pinpoint citation, each document citation corresponding to an assertion of a plurality of assertions in the textual document;
determine, with at least one machine-learning model, at least one candidate document from a plurality of documents for each document identifier in the plurality of document citations;
determine a document from the plurality of documents based on the at least one candidate document for each document identifier of the plurality of document citations;
determine a mapping between each pinpoint citation from the plurality of document citations and a pinpoint citation from the document corresponding to the document identifier for each document citation of the plurality of document citations; and
link the document and the pinpoint citation from the document to at least one document citation of the plurality of document citations in the textual document.

18. The computer program product of claim 17, wherein determining the at least one candidate document from the plurality of documents for each document identifier comprises:
for each assertion of the plurality of assertions having a common document identifier, comparing the assertion to each document of the plurality of documents to determine a similarity score for each assertion and document pair, wherein each candidate document of the at least one candidate document has a similarity score, and wherein determining the document is based on the similarity score of each candidate document of the at least one candidate document.

19. The computer program product of claim 18, wherein determining the document from the plurality of documents based on the at least one candidate document for each document identifier of the plurality of document citations comprises:
determining a probability for each assertion and document pair based on the similarity score for the assertion and document pair and one or more similarity scores for other pairs of the assertion and one or more other documents; and
selecting the assertion and document pair based on the probability.

20. The computer program product of claim 17, wherein the mapping comprises a mapping between a page of the pinpoint citation in a document citation and pagination in the document.
